(19) United States
(12) Patent Application Publication
(10) Pub. No.: US 2005/0155271 A1
(43) Pub. Date: Jul. 21, 2005

(54) Whale-safe rope

(76) Inventor: Norman L. Holy, Yardley, PA (US)

Correspondence Address: John J Simkanich;Paul & Paul, 2900 Two Thousand Market Street, Philadelphia, PA, 19103, US

(21) Appl. No.: 10/516,900

(22) PCT Filed: Sep. 8, 2003
(86) PCT No.: PCT/US03/27932

Related U.S. Application Data
(60) Provisional application No. 60/408,890, filed on Sep. 9, 2002.

(51) Int. Cl. A01K 71/00; A01K 73/00; A01K 75/00; A01K 91/00

(52) U.S. Cl. 43/7; 43/44.98; 43/100

(57) ABSTRACT

A rope comprising weak fibers for use with fishing gear, wherein the rope has a diameter between 5/16 inch and 1 inch and breaks between 600 and 2200 pounds of pulling tension. The rope is ideal for netfishing or trapfishing since its use will reduce deaths in whales and other cetaceans which currently occur during netfishing or trapfishing. Netfishing is performed with a net which incorporates the inventive rope as a head rope in the net. Trapfishing is performed with a multisectional rope which is attached to a trap at one end and is attached at the opposite end to a buoy wherein a section of the multi sectional rope attached to the buoy is the inventive rope.

### TECHNICAL FIELD OF THE INVENTION

The present invention is drawn to a rope comprising weak fibers for use with netfishing or trapfishing gear, which breaks in the range of 600-2200 lbs of pulling tension. The breaking property gives the inventive rope the advantage that whales and other members of the cetacean family will not get entangled to such an extent as to cause death.

### BACKGROUND OF THE INVENTION

Whales encounter ropes in the oceans of the world used as part of fishing gear and often die as a consequence of this encounter. The number lost is in the hundreds each year. The rope will wrap around flippers, the body, especially the head, the tail (fluke) or is caught in the baleen. This danger extends beyond whales to other members of the cetacean family (cetaceans consist of whales, dolphins, and porpoises).

When an animal becomes entangled in the rope, the animal can die from either the rope cutting into the animal's flesh with the consequence of the animal bleeding to death, or because the wound caused by the rope becomes infected. Right whales, numbering only 350 in the North Atlantic in 2003, are particularly vulnerable to ropes in the ocean since they “skim-feed”, i.e., they swim at the surface with their mouths open to engulf and filter out small organisms as food. This type of feeding exposes them to the possibility of taking a rope into their mouths, with the rope catching in their baleen. Of the eight right whales known to have been entangled in 2002 in the North Atlantic, only one was freed of its burden by rescuers cutting the ropes. The fates of the other seven are unknown, but it's highly likely the whales died. An entangled animal is difficult to find in the vast ocean, and even if rescuers are able to locate the animal, it is very difficult to approach close enough to cut the ropes, and such efforts often exhaust the animal. The financial cost of attempting to rescue one entangled whale can be as high as $250,000. Rescuing these animals by cutting the ropes is not an adequate answer to reducing cetacean deaths.

In a recent report (SC/55/BC, 2003) to the International Whaling Commission, authored by Andy Read of Duke University, it is estimated that hundreds of thousands of cetaceans are entangled in gillnets each year. Gillnets can be as long as a mile in length and 10 feet high and have a rope (the so-called “headrope”) along the top of the net. Gillnets can be fished either at the surface (driftnets) or on the bottom (sink gillnets). When a whale swims into a gillnet it often rolls, resulting in wrapping the gear around its body. As the whale struggles to free itself, it readily breaks the filaments of the net. But its efforts rarely, if ever, succeed in breaking the headrope. Sometimes the rope will slip from the body and the animal becomes free, but too often the rope remains wrapped around the animal until it dies.

Gillnets are not the only type of gear that is dangerous to cetaceans. Ropes used in the trap fisheries such as for lobsters, crabs, and eels kill many whales each year. This danger to the whale is very real as illustrated by the fact that there are approximately 12 million lobster traps in the Gulf of Maine for about eight months of the year. The story is similar for virtually all the oceans of the world: entanglement of cetaceans in ropes in the marine environment is a worldwide problem.

Conventional rope used on the top of gillnets, the headrope, typically has a breaking strength of 2200-3000 pounds for a rope in the diameter range of 5/16-7/16 inches.

One attempt to reduce the number of whales killed by ropes is to use a breakaway coupling. Break-away couplings typically break at 1100 lb of tension and is inserted between the rope and the buoy. The theory is that the whale can generate 1100 lb of tension and the buoy will separate from the rope and the rope will slide off the animal. This type of invention is claimed by DeDoes (U.S. Pat. No. 6,457,896) and by Paul et al. (U.S. Pat. No. 5,987,710). Break-away couplings are now required in some fishing locations. However, the effectiveness of this approach is unclear, since the use of break-away couplings has not resulted in a measurable drop in whale deaths from ropes. Perhaps some animals are so entangled that the rope cannot slide away even without the buoy attached, or there may be a knot in the rope that prevents it from sliding through the baleen.

It is an object of the present invention to provide an economical novel system for use in fishing gear comprising ropes which reduces the likelihood of cetacean deaths by entrapment and/or entanglement in these ropes.

### SUMMARY OF THE INVENTION

An aspect of the present invention is a rope comprising weak fibers for use with fishing gear, wherein the rope has a diameter of 5/16 inch to 1 inch and breaks between 600 and 1400 pounds of pulling tension. The rope is ideal for netfishing or trapfishing since its use will reduce deaths in whales and other cetaceans which currently occur during netfishing or trapfishing. Netfishing is performed with a net which incorporates the inventive rope as a head rope in the net. Trapfishing is performed with a multisectional rope which is attached to a trap at one end and is attached at the opposite end to a buoy wherein a section of the multisectional rope attached to the buoy is the inventive rope.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### DETAILED DESCRIPTION OF THE INVENTION

In an embodiment of the present invention, the rope at the top of the gillnet, the headrope, has a breaking strength of 300-2200 lb and will still be able to serve its function. Indeed, when a fisherman brings the gillnet up onto the boat from the water, a tension of only a few hundred pounds, just 300-500 lb is applied to the rope itself While the rope should be strong enough to provide a margin of safety, a rope breaking at tensions 2200 lb would be safe for the fisherman, and make it easier for the whale to free itself. A weak headrope, one breaking well below the break strength of conventional ropes, might reduce whale deaths. Preferably, the weak headrope will break between 60-1400 lbs of pulling tension.

In the trap fisheries, such as lobsters and crabs, a rope is used which goes from the buoy at the surface of the water down to the first trap on the bottom. The length of this rope may be as short as 10 feet or as long as 600 feet, depending on the depth of the water where the traps are located. The length of this rope is generally 30% longer than the depth of the water because this extra line is necessary to prevent the ocean current from sinking the buoy.

Whales and other cetaceans become entangled in this type of rope. This entanglement situation will not be resolved by using a weak rope over the entire distance from the buoy to the bottom. When hauling his traps, the fisherman places the rope into a trap hauler (also called a pot-hauler) and brings the traps up to the surface very rapidly, placing tensions of 600 pounds or more on the rope. Sometimes another string of traps will overlay his traps and the rope must be strong enough to bring both sets of the traps to the surface. This requires a very strong rope.

There is, however, a place for the inventive weak rope in trap fisheries. While a whale may become entangled in rope anywhere between the buoy and first trap, the most likely location is that portion closest to the surface of the water. When the fisherman hauls his traps, he'll place the rope in the hauler with his boat heading into the current (or in a direction to cause slack in the rope). He begins to haul the rope onboard the boat but this action will not immediately lift the traps off the bottom. The top 10-30% of the rope is retrieved without the weight of any traps, and as such, this portion of the rope does not experience high tensions during hauling. This top length of weak rope is made In one embodiment of the invention, the very top part of the rope, that very portion most dangerous to whales, could be weak, i.e., the top 10-30% length of rope (usually less than 50 feet), preferably, the top 10-20% length of rope could be made to have a break strength of less than 2,200 lbs. Preferably, the break strength is 600-1,400 lbs, more preferably, 600-1150 lbs.

Thus, the inventive weak rope is useful in both gillnets and the top part of the rope in trap fisheries. If ropes were weaker, whales would be able to free themselves. While it is not entirely clear how much force a whale can generate while swimming through the water, tests at the National Marine Fisheries Service have established the target of 1100 lb breaking strength for ropes as a value for what a whale could break. There has been a call for this type of rope since the year 2000, but no such product has appeared on the market, pointing to the difficulty of making such a product.

A rope that would break at 1100 lb could be made of cotton or jute or some other natural fiber, for example, and whales likely could break the rope. Ropes of such fibers are not considered to provide an adequate solution, however, because ropes made of natural fibers biodegrade fairly rapidly in an ocean environment and quickly lose their strength. Thus, ropes of natural fibers do not meet the needs of the fishermen. A rope that initially breaks at 1100 lb, but then breaks at some fraction of this value a few weeks later places the fisherman in danger of being hit by a rope that breaks during hauling. What is needed is a rope that has a nearly constant strength over a longer period of time than would be found by ropes made of natural fibers.

One logical approach to making the ropes weaker would simply be to reduce the diameter of the rope. This obvious solution, however, is not the answer because a smaller diameter rope would cut into the animal at a faster rate. Furthermore, a smaller diameter rope would not work well in the current hauling mechanism on a fishing boat. The problem of cetacean deaths in ropes will not be solved by reducing rope diameters. What is needed is a weak rope having a diameter in the range of current ropes, i.e., 5/16-1 inch. However, the rope could have a diameter of greater than 1 inch, because it would cut into the animal more slowly. Preferably, the weak rope has a diameter of 5/16 to ½ inch.

One straightforward method would be to make ropes with the ability to degrade photochemically and this would, in theory, reduce incidental cetacean deaths. By mixing agents into the rope that will oxidize in the presence of UV light, will make a rope that photodegrades. Since whales breathe air when they surface, the rope would be exposed to the ultraviolet wavelengths of sunlight. The problem is the useful lifetime of this type of product would be brief and the fisherman might have to store the rope in the dark when not in use.

In light of this need, the present invention provides a new concept in making rope that is sufficiently weak that whales can break it. The weak rope should not degrade too rapidly under use conditions. The rope should also possess certain other properties that are necessary for adequate performance. One important quality, given that gillnets can be up to a mile in length, is that the rope will not stretch too much. A highly elastic rope will skew the net as it is being hauled because the headrope will stretch while the rope (“lead line”) at the bottom of the net does not. The rope that is needed should not have an elongation of greater than 25% and preferably is under 20%.

The rope can be made of any thermoplastic resin. The thermoplastic resin includes polyamide, such as nylon 6 or nylon 6/6; polyacrylic; polyester, such as polyethyleneterephthalate; polyolefin, preferably polyethylene and/or polypropylene; or blends, mixtures, or copolymers thereof. Preferably, the thermoplastic resin is polyethylene, a mixture of polyethylene with polypropylene or a copolymer of polyethylene and acrylic acid.

The thermoplastic resin can be crosslinked to reduce the elasticity of the fibers in the rope. Any method known in the art for crosslinking the thermoplastic resins can be used.

One method for making a weak rope is to reduce the draw ratio. In order to increase the break strength of fibers, the fibers are drawn, i.e., pulled in the longitudinal direction after the fibers have been spun. The amount the fibers are drawn is expressed as a draw ratio and is a measure of the increase in length of the fibers once pulled. Experiments were performed to make a weak rope by reducing the draw ratio during the making of the yarn. Instead of a conventional draw ratio of 7-12:1 for either polypropylene or a blend of polypropylene/polyethylene, the draw ratio was dropped to 6.3:1. The resulting fibers were somewhat weaker, however, the yarn (and of the rope made from it) was too elastic so that the elongation was unacceptable for the desired product.

It has been unexpectedly discovered that weak rope can be prepared by blending materials of limited compatibility with polyolefins. A weak rope can be made by blending 90-60% (by weight) polypropylene with 10-40% (by weight) polyethylene, provided that the two polymers have quite different properties. In one embodiment, the PP and PE polymers have melt flow rate values (MFR, at 230° C./2.16 kg) which differ by a value of at least 5 g/10 min. Preferably, the MFR values differ by at least 15 g/10 min, most preferably, the melt flow index values MFR values differ by 20-50 g/10 min. It is preferred that the PE have a higher MFR than the PP. A low break strength rope is achieved by mixing PE having a MFR >50 g/10 min with PP having a MFR <15 g/10 min. In these PP-PE blends, normally PP will serve as the continuous phase and PE the discontinuous phase. Preferred blends consist of 70-85% PP and 30-15% PE.

In yet another embodiment, PE having a broad molecular weight distribution (MWD=Mw/Mn as measured by size exclusion chromatography with a polystyrene standard) is mixed with PP. Preferably, the MWD is >3, more preferably, the MWD is >4. The break strength of this sample having broad molecular weight PE can be further reduced by blending in 5-15% amorphous PP.

Using dissimilar materials to achieve a weak product extends beyond a blend of two similar but not entirely compatible polymers. One or more organic or inorganic particles can be added to the plastic to improve the properties of the product, e.g., glass fibers are added to plastics to enhance certain strength characteristics, or to reduce warping (see examples: JP 11138534, JP 11000926, EP 794,214, U.S. Pat. No. 6,326,551, U.S. Pat. No. 6,280,468, or U.S. Pat. No. 4,770,926). Other fillers are normally added to strengthen or reinforce a plastic, providing better wear characteristics, as exemplified by U.S. Pat. No. 4,125,406, WO 95/31593, EP 790,335, DE 10032804, DE 10027297, and pre-grant published U.S. patent application No. 2003-039831. There are thousands of references demonstrating the use of fillers added to plastics to improve hardness, scratch resistance, or cut resistance, or wear properties, or lower costs. The key to having improved strength properties is to add the fillers in a relatively small amount.

It has been discovered that if enough filler is added, the strength of fibers, yarns, and ropes can be decreased. In one embodiment, the fibers are prepared with sufficient filler to decrease the tensile strength of the thermoplastic polymer by at least about 25% compared with a thermoplastic polymer without said filler, preferably the length of said fiber is decreased by at least about 50% compared with a fiber comprising said polymer without said filler. Most preferably, the strength of said fiber is decreased by at least about 75% compared with a fiber comprising said polymer without said filler.

Generally substantial weakening of tensile properties will occur if 10 or more volume percent of the thermoplastic is occupied by filler during the manufacturing process. The strength of the fiber, yarn, or rope made from these yarns decreases as the filler level increases. The desired tensile strength of the fiber, yarn, or rope can be achieved by adjusting the amount of filler added.

Adding fillers in the range of 20-70% (by volume) filler is the preferred approach to making weak rope. The filler can be insoluble or completely soluble in water. If the filler is soluble, a small amount may dissolve in seawater during use. However, it was found that even completely soluble fillers such as NaCl are retained in the fibers of the rope even during use, since the filler particles are sufficiently encapsulated by polymers.

To make fibers of the polymers, the average particle size of the filler additive should be under 120 microns, preferably under 100 microns, most preferably under 50 microns, and even more preferably under 10 microns. The average particle size can be under 1 micron without a deleterious effect on the properties of the composition. In typical extruders, a filtering screen is used to remove large particles (such as insufficiently melted polymers or foreign particles). It has been found that some fillers bridge; thus, even though the particle size would suggest that the particles should pass through the screens without difficulty, the backpressure in the extruder rises very quickly. One option for addressing this problem with some fillers, e.g., starch, is to remove some of the filtering screens in the extruder. Another option is to add a lubricant such as a soap to keep the particles separated. Preferably, the soap is a stearate such as calcium or zinc stearate. Also, the particles can be coated with a polar agent to keep from agglomerating in the nonpolar thermoplastic medium. Such polar agents include ethylene glycol and/or urea.

Another approach to creating weak fibers is to use a foaming agent. The fibers containing closed foam cells may have sufficient volume of cells such that the rope will have a density lower than water and will actually float. However, a floating rope is particularly dangerous to whales since they spend considerable time at the surface to breathe. Thus, these floating ropes should be attached to a weighted object such as a metal trap or a net formed of a denser rope. Also, the rope containing foamed cells could be formed with a heavy filler. Thus, a combination of foaming agent and heavy filler would be acceptable as long as the rope made from such materials sinks.

Useful fillers include starch, talc, silica, barium sulfate, calcium sulfate, calcium carbonate, clay, diatomatious earth, silica, alumina, calcium carbonate, barium sulfate, sodium carbonate, magnesium carbonate, magnesium sulfate, barium carbonate, kaolin, carbon, calcium oxide, magnesium oxide, aluminum hydroxide, titanium dioxide, talc, mica, wollastonite, organosilicone powders, sodium hydrogen sulfate, sodium phosphate, sodium hydrogen phosphate, sodium carbonate, sodium hydrogen carbonate, potassium carbonate, sodium chloride, potassium chloride, alumina trihydrate, calcium silicate, and magnesium silicate calcium silicate, iron oxides, aluminum silicate, sand, clay and mixtures thereof. Preferably, the filler is barium sulfate, iron oxide, and sodium chloride. Most preferably, the filler is barium sulfate which is also known as barite or barytes.

### EXPERIMENTAL

In the following samples, unless noted otherwise, the wt % is calculated based on the total weight of the sample. Fibers of Samples 1-21 were tested for tensile strength according to test methods defined by The Cordage Institute, test method CI 1500 and has units of gram/denier. Samples 22-47 were formed into a rope and were measured for “Break Strength.” The break strength is measured using ⅜ inch rope with a load cell machine, which is set up to anchor one end of the rope and wind the other end of the rope until the rope breaks and measuring the force (in lbs) necessary to break the rope.

### EXAMPLES 1-21

Polypropylene pellets, MFR=3, were mixed with polyethylene (PE1), a LDPE with MFR of 30 and a MWD of 4.3, and/or polyethylene (PE2), a LDPE with MAR of 75 and a MWD of 5.5 and a BaSO₄ blend (46% wt % Blanc Fixe Micro, 13% by weight LDPE of MFR 250, and 43% by weight PP with MFR 80, wherein the wt % is calculated based on the total weight of the BaSO₄ blend). Samples were prepared on a single-screw extruder and the resulting yarns were tested for tensile strength.

TABLE 1

| | | | | BaS0₄ | | Tensile |
|---|---|---|---|---|---|---|
| | PP | % PE1 | % PE2 | Blend | Draw | Strength |
| Sample | (wt %) | (wt %) | (wt %) | (wt %) | Ratio | g/d |
| 1 | 75 | 25 | 0 | 0 | 11.67 | 8.5 |
| 2 | 75 | 25 | 0 | 0 | 8.75 | 7.6 |
| 3 | 75 | 25 | 0 | 0 | 7.78 | 5.5 |
| 4 | 82 | 18 | 0 | 0 | 7.78 | 6 |
| 5 | 82 | 18 | 0 | 0 | 7.78 | |
| 6 | 90 | 10 | 0 | 0 | 7.78 | 5.9 |
| 7 | 95 | 5 | 0 | 0 | 7.78 | 5.6 |
| 8 | 95 | 5 | 0 | 1 | 7.78 | 5.7 |
| 9 | 95 | 5 | 0 | 2 | 7.78 | 5.3 |
| 10 | 95 | 5 | 0 | 5 | 10.05 | 7 |
| 11 | 95 | 5 | 0 | 5 | 12.17 | 7.4 |
| 12 | 80 | 20 | 0 | 10 | 12.17 | 7.5 |
| 13 | 80 | 20 | 0 | 10 | 12.17 | 7 |
| 15 | 80 | 20 | 0 | 20 | 7.37 | 4.8 |
| 16 | 80 | 0 | 20 | 0 | 11.67 | 6.7 |
| 17 | 80 | 0 | 20 | 0 | 7.37 | 5 |
| 18 | 70 | 0 | 30 | 0 | 6.36 | 4 |
| 19 | 80 | 0 | 20 | 5 | 6.36 | |
| 20 | 80 | 0 | 20 | 10 | 6.36 | 4 |
| 21 | 100 | 0 | 0 | 30 | 6.36 | 3.9 |

### EXPERIMENTS 22-28

Corn starch, “CLINTON” (Archer Daniels Midland) was hand mixed with LDPE with a MFR of 3, BaSO₄ blend, NUCREL 3990 (ethylene-acrylic acid copolymer containing 8% acrylic acid from DuPont), a small particle size sodium chloride (EF 325) from Morton Salt, urea, ethylene glycol, and calcium stearate, and were extruded in 20 lb samples in a twin screw extruder and pelletized. The samples were run on a 2 inch extruder to convert the feed into multifilament yarns. Rope was twisted from the yarns produced.

TABLE 2

| | | | | PE-Acrylic | | | | | |
|---|---|---|---|---|---|---|---|---|---|
| | | BaSO₄ | | acid | | | Ethylene | Calcium | Break |
| | Starch | Blend | LDPE | copolymer | NaCl | Urea | glycol | Stearate | Strength |
| Sample | (wt %) | (wt %) | (wt %) | (wt %) | (wt %) | (wt %) | (wt %) | (wt %) | (lb) |
| 22 | 10 | 10 | 55 | 5 | 15 | 1 | 4 | 0.2 | 1070 |
| 23 | 20 | 10 | 50 | 5 | 10 | 1 | 4 | 0.2 | 960 |
| 24 | 20 | 10 | 45 | 5 | 15 | 1 | 4 | 0.2 | 875 |
| 25 | 25 | 15 | 45 | 5 | 5 | 1 | 4 | 0.2 | 760 |
| 26 | 5 | 15 | 55 | 5 | 15 | 1 | 4 | 0.2 | 1180 |
| 27 | 5 | 5 | 90 | 0 | 0 | 0 | 0 | 0 | 2200 |
| 28 | 40 | 0 | 50 | 5 | 0 | 1 | 4 | 0 | 650 |

### EXPERIMENTS 29-36

A first sample of 50 wt % BaSO₄ in polypropylene (MFR=12) was mixed with a second sample of 60 wt % sodium chloride in polypropylene (MFR=12). An amount of propylene (MFR=12) was added to the mixture to give the overall compositions in Table 3. These mixtures were run on a 2 inch extruder fiber line. Rope from the yarns and broken on a load-cell machine.

TABLE 3

| | BaSO₄ | PP | NaCl | Break |
|---|---|---|---|---|
| Sample | (wt %) | (wt %) | (wt %) | Strength |
| 29 | 10 | 75 | 15 | 1620 |
| 30 | 10 | 65 | 25 | 875 |
| 31 | 10 | 45 | 35 | 620 |
| 32 | 15 | 55 | 30 | 730 |
| 33 | 50 | 50 | 0 | 650 |
| 34 | 0 | 100 | 0 | 2300 |
| 35 | 0 | 40 | 60 | 550 |
| 36 | 45 | 45 | 10 | 650 |
| 37 | 20 | 80 | 0 | 1825 |
| 38 | 0 | 80 | 20 | 1670 |
| 39 | 30 | 55 | 15 | 550 |

### EXPERIMENTS 40-48

20 lb samples of various fillers are added to polypropylene (MFR=12) and are mixed in a twin-screw extruder and pelletized. These samples are run through a 2 inch extruder multifilament/yarn line. Rope is made from the yarns and the break strength is measured on a load-cell machine.

TABLE 4

| | | | | Break | Rope |
|---|---|---|---|---|---|
| | | PP | Wt % | Strength | Diameter |
| Sample. | Filler | (wt %) | Filler | (lb) | (in) |
| 40 | alumina | 75 | 25 | 1740 | ⅜ |
| 41 | silica | 65 | 35 | 1850 | ¾ |
| 42 | NaHCO₃ | 65 | 35 | 945 | ⅜ |
| 43 | talc | 55 | 45 | 2100 | 1.0 |
| 44 | TiO₂ | 40 | 60 | 1750 | ¾ |
| 45 | Calcium | 70 | 30 | 1800 | ⅜ |
| | silicate | | | | |
| 46 | KCl | 60 | 40 | 2320 | 1.0 |
| 47 | clay | 65 | 35 | 1400 | ¾ |
| 48 | barite | 50 | 50 | 1085 | ⅜ |

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A rope comprising weak fibers for use with fishing gear, wherein the rope has a diameter between 5/16 inch and 1.0 inch and breaks between 600 and 2200 pounds of pulling tension.

2. The rope according to claim 1, wherein the rope comprises fibers comprising 30-90 wt % of a thermoplastic polymer and a 20-70 wt % filler distributed uniformly in said polymer, said filler having an average particle size under 100 microns.

3. The rope according to claim 1, wherein the rope breaks between 600 and 1250 pounds of pulling tension.

4. The rope according to claim 2, wherein the fibers are prepared with sufficient filler to decrease the tensile strength of the thermoplastic polymer by at least about 25% compared with a thermoplastic polymer without said filler.

5. The rope according to claim 2, wherein said filler is at least one selected from the group consisting of starch, sand, barium sulfate, barites, iron oxide and sodium chloride.

6. The rope according to claim 2, wherein said thermoplastic polymer is at least one selected from the group consisting of polyamide, polyacrylic acid, polyester, polyolefin, and copolymers thereof.

7. The rope according to claim 6, wherein said thermoplastic polymer is polyethylene; a mixture of polyethylene with polypropylene; or a copolymer of polyethylene and acrylic acid.

8. The rope according to claim 1, wherein said weak fibers are formed of a blend of at least two thermoplastic polymers having limited compatibility.

9. The rope according to claim 8, wherein the at least two thermoplastic polymers have melt flow index values which differ by a value of at least 5 g/10 min.

10. The rope according to claim 9, wherein the blend consists of 90-60 wt % polypropylene and 10-40 wt % polyethylene wherein the wt % is based on the total weight of the weak fiber.

11. The rope according to claim 9, wherein the at least two thermoplastic polymers have melt flow index values which differ by 20-50 g/10 min.

12. The rope according to claim 8, wherein the at least two thermoplastic polymers are polyethylene having a molecular weight distribution >4 in a concentration of 85-95 wt % and amorphous polypropylene in a concentration of 5-15 wt %, wherein the wt % values are based on the total weight of the weak fibers.

13. A method of reducing deaths in whales and other cetaceans during netfishing or trapfishing comprising netfishing with a net which incorporates the rope of claim 1 as a head rope in the net or trapfishing with a multisectional rope which is attached to a trap at one end and is attached at the opposite end to a buoy wherein a section of the multisectional rope attached to the buoy is the rope of claim 1.

14. The method of reducing deaths in whales and other cetaceans during trapfishing according to claim 13, wherein the section of the rope of claim 1 consists of up to 50 feet of the length of the multisectional rope.

15. The method of reducing deaths in whales and other cetaceans during trapfishing according to claim 14, wherein the traps are used to catch lobster, crab or eel.

16. A fishnet comprising headrope and netting rope, wherein the headrope is the rope of claim 1 and the netting rope breaks at a higher pulling tension than the headrope.

17. A multisectional rope for trapfishing wherein the multisectional rope has a weak section and a strong section, wherein the weak section consists of the rope of claim 1 and the strong section consists of a rope which breaks at a higher pulling tension than the weak section of rope.
